(19) United States
(12) Patent Application Publication
(10) Pub. No.: US 2022/0050580 A1
(43) Pub. Date: Feb. 17, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: YUUJI TAKIMOTO, TOKYO (JP); SHINGO UTSUKI, KANAGAWA (JP); REIKO KIRIHARA, TOKYO (JP)

(21) Appl. No.: 17/310,133

(22) PCT Filed: Dec. 17, 2019
(86) PCT No.: PCT/JP2019/049371

§ 371 Date: Jul. 20, 2021

(30) Foreign Application Priority Data
Jan. 28, 2019 (JP) 2019-012190

(51) Int. Cl. G06F 3/0484; G06F 3/0481; G06F 3/01

(52) U.S. Cl. CPC G06F 3/04842; G06F 3/16; G06F 3/013; G06F 3/0481

(57) ABSTRACT

To achieve an object of effectively attracting a user's attention to an item selected on the basis of behavior of a user. An information processing apparatus as one embodiment of solving means includes a controller that outputs content information and an indicator representing an agent onto a display screen, discriminates an object of interest of the content information on the basis of behavior of a user, and moves the indicator in a direction of the object of interest.

### TECHNICAL FIELD

The present technology relates to an information processing apparatus, an information processing method, and a program.

### BACKGROUND ART

In the technical field of sound input systems using the speech recognition technology, which is called “speech agent” or “speech assistant”, for example, there is a technique described in Patent Literature 1. Patent Literature 1 describes that dots are used to display content corresponding to user utterances or information such as notifications and warnings associated with the content.

### CITATION LIST

### Patent Literature

Patent Literature 1: WO 2017/142013

### DISCLOSURE OF INVENTION

### Technical Problem

In input systems based on behavior of a user, like speech recognition and other user interfaces, there has been a problem in that, when an item is selected on the basis of a recognition result obtained by recognizing behavior of the user, the user has the difficulty of determining that the selected item is not based on false recognition. One reason is that the user has the difficulty of recognizing what item has been selected. The above problem is also found in input systems other than those based on the speech recognition.

In view of the above circumstances, it is an object of the present technology to effectively attract a user's attention to an item selected on the basis of behavior of a user.

### Solution to Problem

An embodiment of the present technology for achieving the above object is an information processing apparatus including a controller that outputs content information and an indicator representing an agent onto a display screen, discriminates an object of interest of the content information on the basis of behavior of a user, and moves the indicator in a direction of the object of interest.

In the above embodiment, the controller discriminates the object of interest on the basis of the behavior of the user and moves the indicator in a direction of the object of interest. Thus, according to the above embodiment, it is possible to effectively attract a user's attention to an item selected on the basis of the behavior of the user.

The controller may display related information of the object of interest in response to movement of the indicator in the direction of the object of interest.

The related information of the object of interest is displayed in response to the movement of the indicator in the direction of the object of interest. Thus, it is possible to attract a user's attention to the related information linked with the movement of the indicator.

The controller may change, after discriminating the object of interest, a display state of the indicator to a display state indicating a selection preparation state, and select the object of interest when recognizing behavior of the user that indicates a selection of the object of interest during the display state indicating the selection preparation state of the indicator.

Since the discriminated object of interest is further selected after entering the selection preparation state, it is possible to wait for confirmation by the user during the selection preparation state of the object of interest.

The controller may set the discriminated object of interest to a non-selected state when recognizing that the behavior of the user is negative about the selection of the object of interest during the display state indicating the selection preparation state of the indicator.

When the discriminated object of interest is in the selection preparation state, the object of interest is set to the non-selected state in accordance with the behavior of the user. Thus, it is possible to accept cancellation by the user during the selection preparation state of the object of interest.

The controller may split, when discriminating a plurality of the objects of interest on the basis of the behavior of the user, the indicator into indicators in number of the discriminated objects of interest, and move the split indicators in respective directions of the objects of interest.

When a plurality of objects of interest is discriminated, the indicators are moved in the directions of the respective objects of interest. Thus, even if the objects of interest based on the behavior of the user are not narrowed down to one object of interest, the possibility that an operation against the intention of the user is performed is reduced.

The controller may control at least one of moving speed, acceleration, a trajectory, a color, or luminance of the indicator in accordance with the object of interest.

The movement speed, acceleration, trajectory, color, luminance, and the like of the indicator change in accordance with the object of interest, and thus the user can intuitively grasp the object of interest.

The controller may detect a line of sight of the user on the basis of image information of the user, select content information located ahead of the detected line of sight as a candidate of the object of interest, and discriminate, when subsequently detecting the behavior of the user for the candidate, the candidate as the object of interest.

Since the content information located ahead of the line of sight of the user is set as a candidate of the object of interest of the user, and then the object of interest is discriminated on the basis of the behavior, the possibility of being the object of interest of the user increases.

The controller may discriminate the object of interest on the basis of the behavior of the user and also calculates accuracy information indicating a degree of certainty indicating that the user is interested in the object of interest, and move the indicator in accordance with the accuracy information such that a movement time of the indicator becomes shorter as the certainty becomes higher.

Since the indicator moves at a speed corresponding to the level of the interest of the user, it is possible to provide the user with a comfortable and smooth feeling of operation.

The controller may detect a line of sight of the user on the basis of image information of the user, and move the indicator ahead of the detected line of sight at least once and then move the indicator in the direction of the object of interest.

Since the indicator moves ahead of the line of sight of the user once, it is possible to attract a user's attention.

### BRIEF DESCRIPTION OF DRAWINGS

FIG. 1 is a conceptual diagram for describing an outline of a first embodiment of the present technology.

FIG. 2 is a diagram showing an appearance example of an information processing apparatus (AI speaker) according to the above embodiment.

FIG. 3 is a diagram showing an internal configuration of the information processing apparatus (AI speaker) according to the above embodiment.

FIG. 4 is a flowchart showing the procedure of the information processing for the display control in the above embodiment.

FIG. 5 is a display example of image information in the above embodiment.

FIG. 6 is a display example of image information in the above embodiment.

FIG. 7 is a display example of image information in the above embodiment.

FIG. 8 is a flowchart showing the procedure of the information processing for the display control in a second embodiment.

FIG. 9 is a display example of image information in the above embodiment.

FIG. 10 is a display example of image information in the above embodiment.

FIG. 11 is a display example of image information in the above embodiment.

FIG. 12 is a display example of image information in the above embodiment.

FIG. 13 is a display example of image information in the above embodiment.

FIG. 14 is a display example of image information in the above embodiment.

FIG. 15 is a display example of image information in the above embodiment.

### MODE(S) FOR CARRYING OUT THE INVENTION

Embodiments of the present technology will be described below in the following order.

### 1. First Embodiment

1.1. Information processing apparatus

### 1.2. AI Speaker

### 1.3. Information Processing

### 1.4. Example of Display Output

### 1.5. Effects of First Embodiment

### 1.6. Modified Example of First Embodiment

### 2. Second Embodiment

### 2.1. Information Processing

### 2.2. Effects of Second Embodiment

### 2.3. Modified Example of Second Embodiment

### 3. Appendix

### First Embodiment

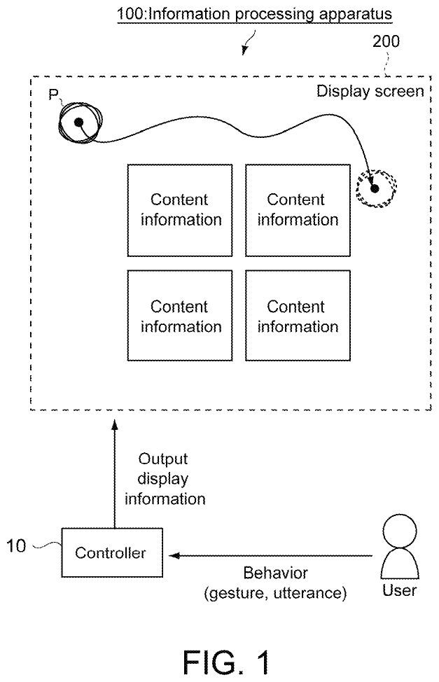

FIG. 1 is a conceptual diagram for describing the outline of this embodiment. As shown in FIG. 1, an apparatus according to this embodiment is an information processing apparatus 100 including a controller 10. The controller 10 outputs content information and an indicator P representing an agent on a display screen 200, discriminates an object of interest of the content information on the basis of behavior of a user, and moves the indicator P in the direction of the object of interest.

### Information Processing Apparatus

The information processing apparatus 100 is, for example, an artificial intelligence (AI) speaker in which various software program groups including an agent program to be described later are installed. The AI speaker is an example of the hardware of the information processing apparatus 100, and the hardware is not limited thereto. A personal computer (PC), a tablet terminal, a smartphone, another general-purpose computer, a television apparatus, an audio/visual (AV) device such as a personal video recorder (PVR), a projector, or a digital camera, a wearable device such as a head-mounted display, or the like can also be used as the information processing apparatus 100.

The controller 10 is configured by, for example, an arithmetic unit or a memory incorporated in the AI speaker.

The display screen 200 is, for example, a display screen for a projector (image projection apparatus), a wall, or the like. Other examples of the display screen 200 include a liquid crystal display and an organic electro-luminescence (EL) display.

The content information is information recognized by the user's sense of vision. The content information includes still images, videos, letters, patterns, symbols, and the like and may be, for example, texts, designs, vocabularies in sentences, design parts such as a map and a photograph, pages, or lists.

The agent program is a kind of software. The agent program uses the hardware resources of the information processing apparatus 100 to perform predetermined information processing, thus providing an agent that is a kind of user interface that behaves interactively with the user.

The indicator P representing the agent may be inorganic or organic. An example of the inorganic indicator is a dot, a line drawing, or a symbol. An example of the organic indicator is a biological indicator such as a character of a person, or an animal or plant. In addition, examples of the organic indicator include indicators using images of a person or user's preference as avatars. When the indicator P representing the agent is configured by a character or an avatar, the representation of a facial expression or an utterance is made possible as compared with an inorganic indicator. This makes it easy for the user to feel empathy. Note that, as shown in FIG. 1, in this embodiment, an inorganic indicator including dots and lines combined is exemplified as the indicator P representing an agent.

The “behavior of a user” is information obtained from information including sound information, image information, biometric information, and other information from a device. Specific examples of the sound information, the image information, the biometric information, and other information from a device will be described below.

The sound information input from a microphone device or the like is, for example, words spoken by the user or sound by clapping the hands. The behavior of the user obtained from the sound information may be, for example, positive or negative details of utterances. The information processing apparatus 100 obtains the details of utterances from the sound information by analyzing the natural language. The information processing apparatus 100 may presume the emotion of the user on the basis of voice, or may presume the affirmative, negative, or ambivalent state according to the time taken until the user responds. When the behavior of the user is obtained from the sound information, the user can perform an operation input without touching the information processing apparatus 100.

The behavior of the user obtained from the image information includes a line of sight, a face orientation, and a gesture of the user, for example. When the behavior of the user is obtained from the image information input from an image sensor device such as a camera, it is possible to obtain behavior of the user with higher accuracy than the behavior of the user based on the sound information.

The biometric information may be input as electroencephalogram information from a head-mounted display or may be input as information of a posture or a head inclination. Specific examples of the behavior of the user obtained from the biometric information include a posture of a nod indicating positive and a posture of shaking the head indicating negative. Obtaining the behavior of the user on the basis of such biometric information provides a merit that an operation input by the user can be performed even when the sound input cannot be performed due to the absence of the microphone device or the like or even when image recognition cannot be performed due to a shielding object or illuminance shortage.

Other devices in the “other information from a device” described above include a controller device such as a touch panel, a mouse, a remote controller, or a switch, and a gyro device.

### AI Speaker

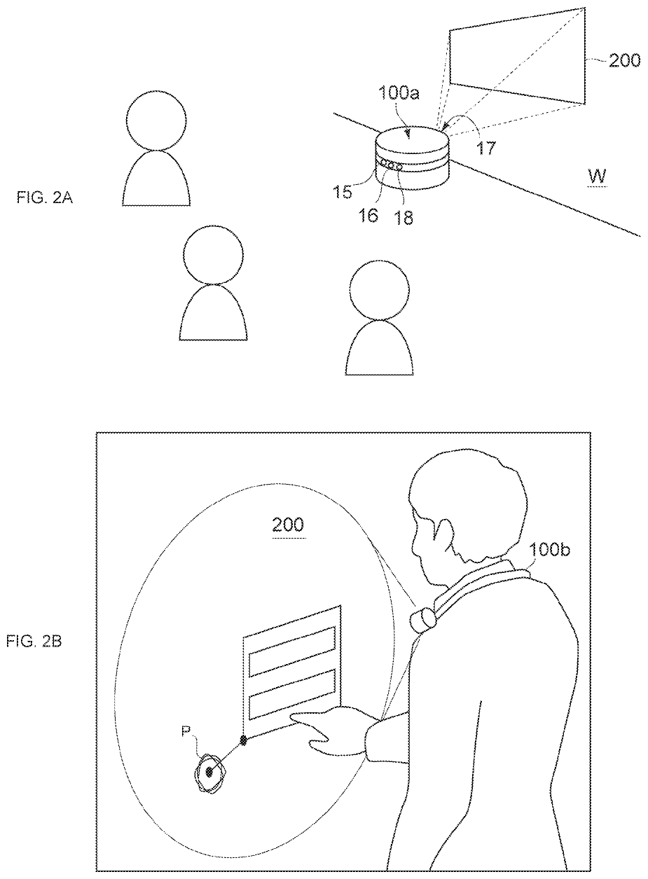

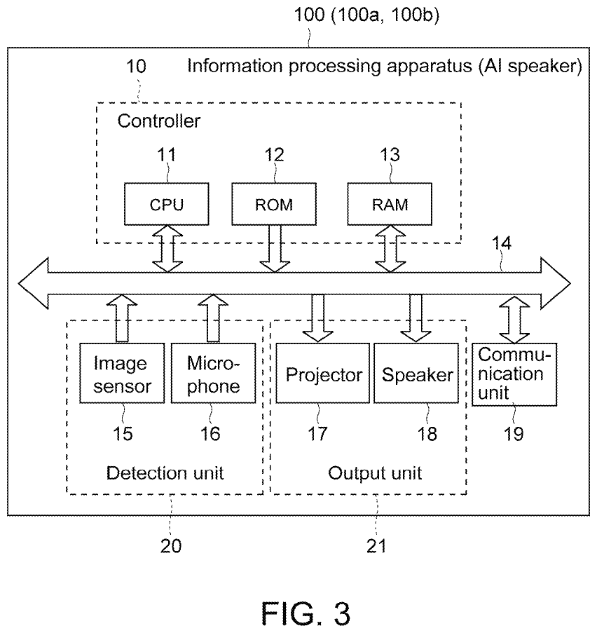

(a) of FIG. 2 is a diagram showing an example of an appearance configuration of an AI speaker 100a, which is an example of the information processing apparatus 100. The information processing apparatus 100 is not limited to the form shown in (a) of FIG. 2 and may be configured as a neck-mounted AI speaker 100b as shown in (b) of FIG. 2. Hereinafter, it is assumed that the form of the information processing apparatus 100 is the AI speaker 100a shown in (a) of FIG. 2. FIG. 3 is a block diagram showing an internal configuration of the information processing apparatus 100 (AI speaker 100a, 100b).

As shown in FIGS. 2 and 3, the AI speaker 100a includes a central processing unit (CPU) 11, a read-only memory (ROM) 12, a random access memory (RAM) 13, an image sensor 15, a microphone 16, a projector 17, a speaker 18, and a communication unit 19. These blocks are connected via a bus 14. The bus 14 allows the blocks to input and output data to and from each other.

The image sensor (camera) 15 has an imaging function, and the microphone 16 has a sound input function. The image sensor 15 and the microphone 16 constitute a detection unit 20. The projector 17 has a function of projecting an image, and the speaker 18 has a sound output function. The projector 17 and the speaker 18 constitute an output unit 21. The communication unit 19 is an input/output interface for the information processing apparatus 1 to communicate with an external device. The communication unit 19 includes a local area network interface, a near field communication interface, or the like.

The projector 17 projects an image on the display screen 200 with the wall W being used as the display screen 200, for example, as shown in FIG. 2. Projection of an image by the projector 17 is merely one embodiment of the display output of the image, and the image may be output for display in other ways (e.g., displayed on a liquid crystal display).

The AI speaker 100a performs information processing by a software program using the above hardware, to provide an interactive user interface through speech utterances. The controller 10 of the AI speaker 100a produces sound and video effects as if the user interface is a virtual interactive partner called “speech agent”.

The agent program is stored in the ROM 12. The CPU 11 loads the agent program and executes predetermined information processing according to the program, thereby implementing various functions of the speech agent according to this embodiment.

### Information Processing

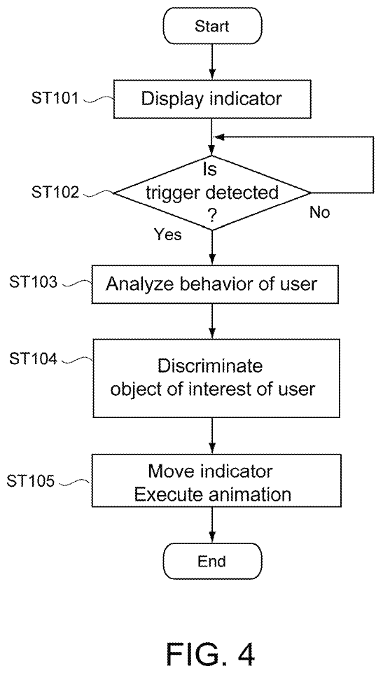

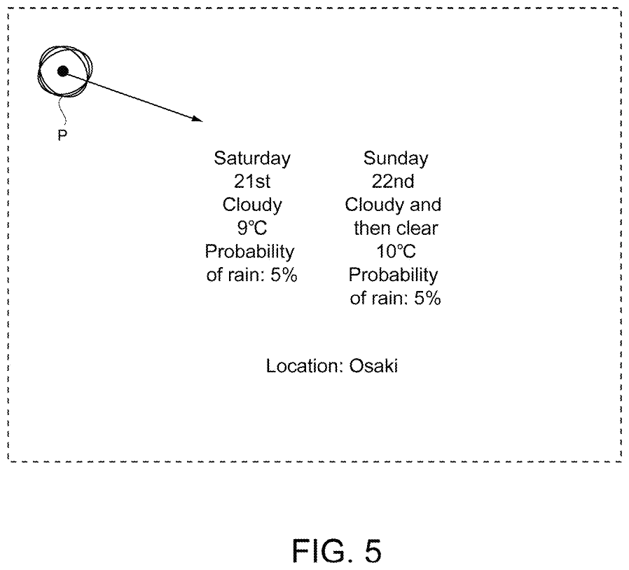

FIG. 4 is a flowchart showing the procedure of processing in which the speech agent supports the information presentation when the information is presented to the user from the speech agent or another application. FIGS. 5, 6, and 7 are display examples of the screen in this embodiment.

### ST101 to ST103

First, the controller 10 displays the indicator P on the display screen 200 (Step ST101). Next, when detecting a trigger (Step ST102: YES), the controller 10 analyzes behavior of the user (Step ST103). The trigger in Step ST102 is an input of information indicating the behavior of the user to the controller 10.

Next, the controller 10 discriminates an object of interest of the user on the basis of the behavior of the user (Step ST104), and moves the indicator P in a direction of the discriminated object of interest (Step ST105). Moving the indicator P involves animation (Step ST105). Hereinafter, Step ST104 and Step ST105 will be further described.

### ST104: Processing of Discriminating Object of Interest

The controller 10 discriminates an object of interest of the user (ST104). The object of interest of the user may be content information itself or some control over the content information. For example, if the content information is a musical piece that can be reproduced by an audio player, the object of interest of the user may be not only the musical piece itself but also the control of the reproduction and stop of the musical piece. In addition, meta information of the content information (detailed information such as a singer of the music piece and recommendation information) is also an example of the object of interest of the user.

When the object of interest of the user is explicitly indicated by the behavior of the user, the controller 10 sets the explicitly indicated one as an object of interest of the user. If the object of interest of the user is not explicitly indicated, the controller 10 presumes an object of interest of the user on the basis of the behavior of the user.

### ST105: Display Output of Indicator

The controller 10 moves the indicator P in the direction of the discriminated object of interest of the user. The moving destination is a position near or overlapping the object of interest of the user, for example, a margin portion around the content information or a position on the content information. For example, if the object of interest of the user is a musical piece set in the audio player, the controller 10 controls the indicator P to move on the reproduction button for reproduction of the audio player.

When moving the indicator P to the moving destination, the controller 10 moves the indicator P so as to pass through a route that does not pass over the content information. When the indicator P passes over the content information, the image of the indicator P is superimposed on the image of the content information or the like, and thus there is a possibility that the attraction effect due to the movement of the indicator P is reduced. However, if the movement path of the indicator P is controlled so as not to pass over the content information, it is possible to effectively attract the user's attention to the indicator P and its moving destination.

Alternatively, when moving the indicator P to the moving destination, the controller 10 may detect a line of sight of the user as an example of the behavior of the user, and may control the indicator P to move on a movement path that temporarily passes through a place, on the display screen 200, which is located ahead of the line of sight of the user. Also in this case, since the attraction effect by the indicator P is high, it is possible to effectively attract the user's attention to the indicator P and its moving destination.

Alternatively, when moving the indicator P to the moving destination, the controller 10 may control the indicator P to move on a movement path such that the indicator P rotates a plurality of times in situ before, during, or after the movement. Also in this case, since the attraction effect by the indicator P is high, it is possible to effectively attract the user's attention to the indicator P and its moving destination. In this case, the controller 10 may change the form of the motion before, during, and after the movement in accordance with the importance of the content information at the movement destination. For example, the indicator P may be configured to rotate twice on the spot after moving to important content information, or rotate three times if it is the most important content information, and to further pop. When such a configuration is provided, users can intuitively understand the importance and value of content information.

When moving the indicator P to the moving destination, the controller 10 controls the movement style of the indicator P so as to move while blinking, periodically changing the luminance, or displaying the trajectory. As a result, the attraction effect by the indicator P is enhanced, and it is possible to effectively attract the user's attention to the indicator P and its moving destination.

Alternatively, the controller 10 may control the movement style of the indicator P such that the speed and/or acceleration of the movement of the indicator P changes when the indicator P passes through a region where content information is displayed on the display screen 200, a region having a change in contrast, a boundary between regions, or the like.

Alternatively, when discriminating the object of interest of the user on the basis of the behavior of the user, the controller 10 may calculate accuracy information indicating the degree of certainty indicating that the user is interested in the object of interest and move the indicator P in accordance with the accuracy information such that a movement time of the indicator P becomes shorter as the certainty becomes higher. That is, the controller 10 increases the speed and/or acceleration of the movement of the indicator P as the certainty becomes higher. Conversely, the controller 10 decreases the speed and/or acceleration of the movement of the indicator P as the certainty becomes lower. As a result, since the indicator P moves at a speed corresponding to the level of the interest of the user, it is possible to provide the user with a comfortable and smooth feeling of operation. Note that the controller 10 may change not only the speed of the movement of the indicator P but also the brightness and motion of the indicator P in accordance with the accuracy.

Alternatively, when moving the indicator P to the moving destination, the controller 10 may change the moving speed in accordance with the utterance speed of the users. For example, the controller 10 counts the number of spoken words per unit time, and when the number of spoken words is lower than the average number of spoken words, the moving speed of the indicator P is made slow. Thus, in the case where the user speaks while hesitating to select content information, the moving style of the indicator P can be changed to a moving style linked to the user's hesitation, so that a user-friendly agent can be produced.

### Example of Display Output

Referring to FIGS. 5, 6, and 7, examples of actual display output (ST105) of the indicator P are shown. In FIGS. 5, 6, and 7, an inorganic indicator called a “dot” is shown as an example of the indicator P.

FIG. 5 shows an example of a display output when the agent of this embodiment supports a weather information providing application. The controller 10 displays a dot representing the agent on the upper left in FIG. 5. When determining that the object of interest of the user is in the weather information on the basis of the behavior of the user such as the user's gaze at the display screen 200, the controller 10 moves the dot (indicator P) to the vicinity of the weather information on Saturday while sounding the details of the weather information, e.g., “The weather on Saturday is cloudy.”

As shown in FIG. 5, the controller 10 moves the dot to a location related to the content information on the basis of the details of the content information, so that the user can be easily understand the location of the content information referred to by the agent.

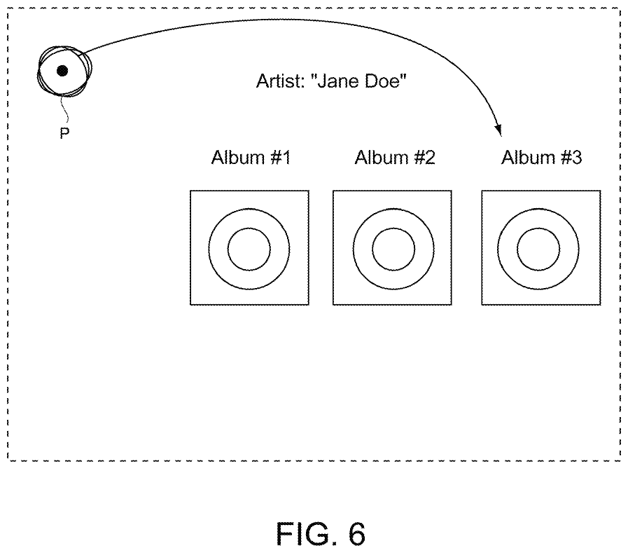

FIG. 6 shows an example of a display output when the agent of this embodiment supports an audio player. As in the case of FIG. 5, the controller 10 displays a dot representing the agent on the upper left in FIG. 6. FIG. 6 also shows a display screen 200 in which a list of albums of an artist is displayed together with images of the albums. In this state, for example, when the user says, “Play No. 3”, the controller 10 analyzes the sound information to understand that the album is the third album for which “No. 3” is displayed, and moves the dot to a margin or the like in the vicinity of the third album.

As shown in FIG. 6, the controller 10 complements the context of the user's speech and understands the user's speech on the basis of the details of the content and the user's speech, and moves the dot to the vicinity of the album, which is determined to be the object of interest of the user. This makes it possible to clearly indicate to the user that the agent understands the user's speech.

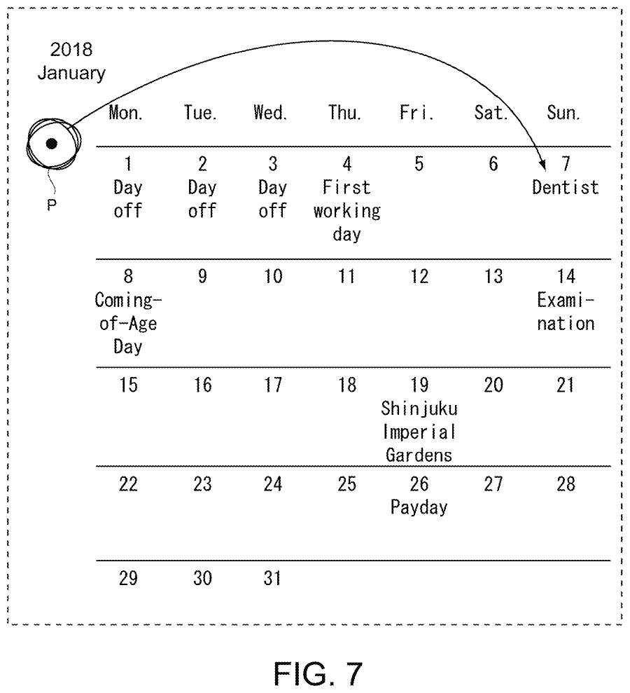

FIG. 7 shows an example of a display output when the agent of this embodiment supports a calendar application. As in the case of FIG. 6, the controller 10 analyzes the sound information when receiving sound information of a user's speech, e.g., “When do I have to see a dentist?”, after the dot is displayed. Subsequently, the controller 10 determines that the date containing the schedule of “dentist” is an object of interest of the user, and moves the dot to the position of the date.

As shown in FIG. 7, the controller 10 complements the context of the user's speech and understands the user's speech on the basis of the details of the content and the user's speech, and moves the dot to the vicinity of the date in the calendar, which is determined to be the object of interest of the user. This makes it possible to clearly indicate to the user that the agent understands the user's speech. Note that, when determining that there is a plurality of objects of interest of the user, the controller 10 splits the dot. For example, when there is a plurality of schedules to see a “dentist”, the controller 10 splits the dot and moves resultant dots to the vicinity of the respective scheduled dates to see a dentist.

### Effect of First Embodiment

In the information processing apparatus 100, since the controller 10 discriminates the object of interest on the basis of the behavior of the user and moves the indicator P in the direction of the object of interest, the information processing apparatus 100 can effectively attract the user's attention to the item selected on the basis of the behavior of the user.

In this embodiment, the controller 10 displays the indicator P representing the agent on the display screen 200, and the content information is displayed as if a human presenter pointed it with an instruction bar or a finger. The user can intuitively grasp the process of the operation performed by the agent on behalf of the user and the details of the feedback.

In this embodiment, since the movement speed, acceleration, trajectory, color, luminance, and the like of the indicator P change according to the object of interest, the user can intuitively grasp the object of interest.

### Modified Example of First Embodiment

The function of the agent in the above-described embodiment is mainly the function of feeding back the operation of the user. However, instead of the operation of the user, feedback of the operation performed independently by the agent may be displayed by the indicator P.

In this modified example, examples of the operation performed independently by the agent include operations that may harm the user, such as data deletion and modification. The controller 10 expresses the progress of these operations by animation of the indicator P.

According to this modified example, it is possible to give the user time for determining an instruction, such as cancellation, given to the agent from the user. Further, an operation step of a dialog using speeches, such as “execute/cancel”, is interposed conventionally, but according to this modified example, this step can be omitted.

Note that, in this modified example, the display color and the display mode of the indicator P indicating the feedback of the operation performed independently by the agent may be different from the display color and the display mode of the indicator P indicating the feedback of the operation of the user. In this case, the user can easily discriminate the operation performed by the agent's discretion, and the possibility of giving the user a feeling of discomfort can be reduced.

### Second Embodiment

Hereinafter, a second embodiment according to the present technology will be described. In the drawings according to this embodiment, the components and processing blocks similar to those of the first embodiment are denoted by the same reference symbols, and description thereof may be omitted.

### Information Processing

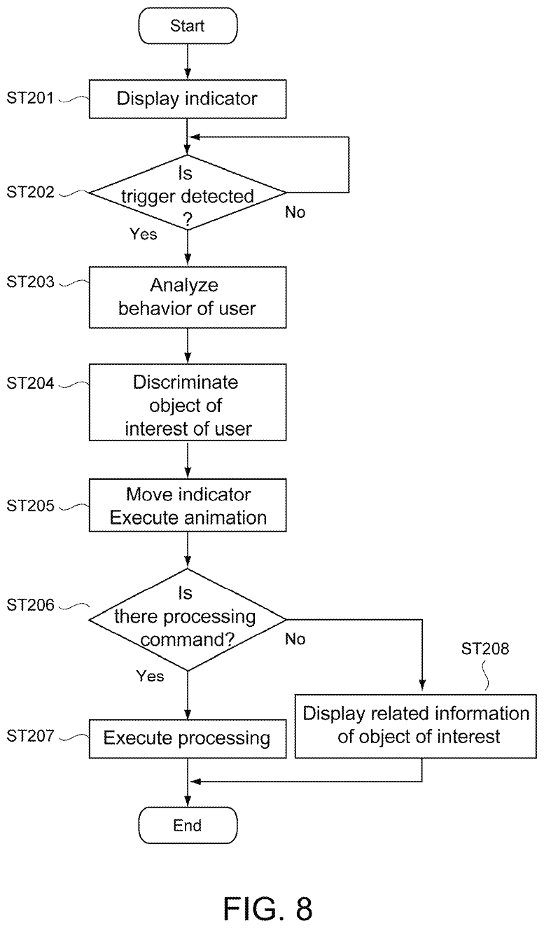

FIG. 8 is a flowchart showing an example of the procedure of the information processing for the display control of the speech agent by the controller 10. The processing from Step ST201 to Step ST205 in FIG. 8 is processing similar to the processing from Step ST101 to Step ST105 in FIG. 4.

First, the controller 10 displays the indicator P on the display screen 200 (Step ST201). Next, when detecting a trigger (Step ST202: YES), the controller 10 analyzes behavior of the user (Step ST203). The trigger in Step ST202 is an input of information indicating the behavior of the user to the controller 10.

Next, the controller 10 discriminates an object of interest of the user on the basis of the behavior of the user (Step ST204), and moves the indicator P in a direction of the discriminated object of interest (Step ST205). Moving the indicator P involves animation (Step ST205).

Next, the controller 10 determines whether or not there is a processing command based on the behavior of the user or the like (Step ST206). If there is a processing command, the controller 10 executes the processing (Step ST207). If there is no processing command, the controller 10 displays the related information of the object of interest (Step ST208).

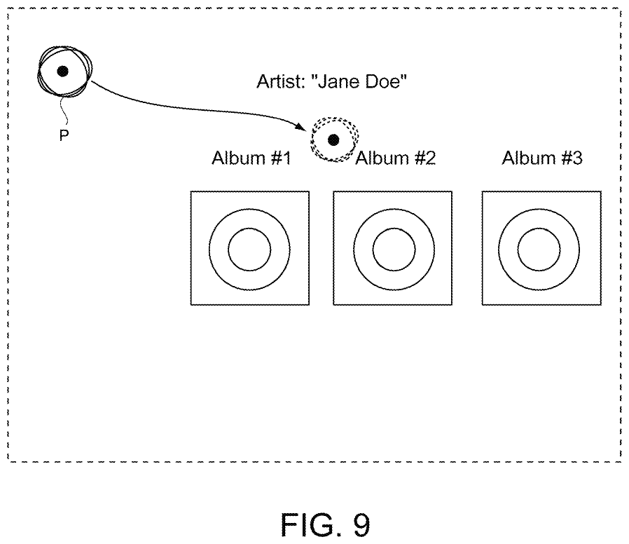

In the following, the problems of conventional AI speakers will be considered first, and then the details of the processing blocks will be described with reference to the display output examples of FIGS. 9, 10, and 11.

### Problems of Conventional AI Speakers

Some conventional AI speakers on the market have screens and display output functions. However, speech agents are not displayed in those speakers. Similarly, conventional speech agents display search results by outputting sounds or displaying screens. However, the speech agents themselves are not displayed on the screens. Further, there are also conventional techniques of displaying on screens agents that guide how to use various kinds of application software, but such conventional agents are mere dialogs for the user to enter questions and dialogs to output their responses.

Conventional AI speakers and speech agents on the market do not support the case where multiple users simultaneously use them. Further, the case where multiple applications are simultaneously used is not supported. In addition, conventional AI speakers and speech agents having the display output functions can display a plurality of pieces of information on the screens, but in this case, the user may have the difficulty of knowing which information in the plurality of pieces of information is information indicating a response from the speech agent or information indicating recommendation of the speech agent.

A touch panel has been conventionally known as a device for providing an operation input function, other than the sound input system (AI speaker). In the touch panel, when the user makes an incorrect operation input, the user can cancel the operation input by performing an operation such as shifting the finger without separating the finger from the touch panel. However, in the sound input system or AI speaker, it is difficult for the user to cancel the operation input by the utterance after the user speaks.

### ST201: Display Indicator P Representing Speech Agent

In contrast to the conventional AI speakers, the AI speaker 100a according to this embodiment causes the speech agent to appear as a “dot” on the display screen 200 (see the display example of FIG. 9). The dot is an example of an “indicator P representing a speech agent”. In addition, the AI speaker 100a assists the user in selecting and obtaining information by using the dot. Alternatively, the AI speaker 100a supports switching between a plurality of applications or a plurality of services and cooperation between applications or services by using the dot.

Specifically, the AI speaker 100a causes the dot representing the speech agent to express the state of the AI speaker 100, for example, the state indicating whether or not an activation word is necessary, or to whom the AI speaker 100a is capable of responding by sound. In such a manner, the AI speaker 100a indicates, by the dot, a person who is focused to respond by sound when the AI speaker 100a is used by multiple people. This makes it possible to provide an AI speaker that is easy to use even when multiple people simultaneously use the AI speaker.

The expression of the dot provided by the AI speaker 100a according to this embodiment changes in accordance with the details of the information given to the user by the AI speaker 100a. For example, in the case of good information, bad information, or special information for the user, the dot bounces or changes to a different color from a usual one, depending on each case. In this case, the controller 10 analyzes the details of the information and controls the display of the dot according to the analysis result. For example, in an application for transmitting weather information, the controller 10 changes the dot to a blue color in the case of being rainy and changes the dot to a color of the sun in the case of being sunny in accordance with the weather information. In addition to the color, the controller 10 may control the display of the dot by combining changes in the color, the form, and the moving way of the dot in accordance with the details of the information given to the user. According to such display control, the user can intuitively grasp the outline of the information to be given to the user.

As described above, in the AI speaker 100a according to this embodiment, the indicator P representing the speech agent is displayed on the display screen 200, so that the user can intuitively grasp where the information presented to the user is on the display screen 200. Here, the information presented to the user is, for example, information indicating a response from the speech agent or information indicating a recommendation of the speech agent.

In addition, the controller 10 may change the color or form of the indicator P in accordance with the importance of the information presented to the user. This allows the user to intuitively understand the importance of the information presented.

### ST202 to S204: Discriminate Object of Interest on Basis of Behavior of User

The controller 10 analyzes behavior including a voice, a line of sight, and a gesture of the user to discriminate an object of interest of the user. Specifically, the controller 10 analyzes the image of the user input by the image sensor 15, and specifies a drawing object that is located ahead of the line of sight of the user among drawing objects displayed on the display screen 200. Next, in a state where the drawing object is specified, when an utterance including a positive keyword such as “want to listen” or “want to watch” is detected from the sound information of the microphone 16, the controller 10 discriminates the details of the specified drawing object as an object of interest.

The reason why the above-mentioned method of presuming the object of interest is employed is generally as follows: a user takes a preliminary action of sending a line of sight to an object of interest immediately before directly approaching the object of interest (e.g., utterance such as “want to listen” or “want to watch”). According to the above-mentioned presuming method, the object of interest is selected from the targets for which the preliminary action has been taken, and thus the possibility of selecting an appropriate object is increased.

The controller 10 may further detect the direction in which the user's head is directed from the image of the user input by the image sensor 15 and discriminate the object of interest of the user on the basis of the direction in which the user's head is directed. In this case, the controller 10 first extracts a plurality of candidates from the objects in the direction in which the head is directed, extracts objects located ahead of the line of sight from the candidates, and then discriminates an object extracted on the basis of the details of the utterance as the object of interest of the user.

Parameters that can be used to discriminate the object of interest of the user include the above-mentioned line of sight and the direction of the head, as well as a walking direction and directions in which the fingers and hands are directed. In addition, the user's environment and state (e.g., whether the hand is available or not) can also be a parameter for discrimination.

In this embodiment, since the controller 10 uses the above-described parameters for discriminating the object of interest to narrow down the objects of interest on the basis of the order in which the preliminary actions are performed, the object of interest is discriminated with high accuracy. Note that the controller 10 may propose an object of interest when the controller 10 fails to discriminate an object of interest of the user.

FIG. 9 shows a display example of a speech agent that supports an audio player. As shown in FIG. 9, the audio player displays an album list, and an agent application related to the speech agent displays a dot (indicator P). In this state, when the user murmurs the name of the second album, the controller 10 discriminates the second album as the object of interest of the user.

### ST205: Move Indicator

Further, the controller 10 of the AI speaker 100a further moves the dot (indicator P) to cause the user to easily notice the information presented by the AI speaker 100a. When the details of the presented information change, the user notices the change more easily. Note that, in this case, it is more effective to enlarge the area where information is presented in accordance with the change.

The controller 10 of the AI speaker 100a further moves the dot to an object selected by the user. Thus, the user can easily recognize what is selected by the operation input. For example, when the user says, “Show No. 1”, the AI speaker 100a may erroneously recognize it as “Show No. 7” (which is an erroneous recognition due to sound similarity between Ichi-ban and Shichi-ban). In this case, according to this embodiment, the dot moves to “No. 7”, and processing related to “No. 7” is then executed (for example, the musical piece of No. 7 is reproduced). Thus, the user can know that the user's operation input has been erroneously recognized when the dot starts to move to “No. 7”.

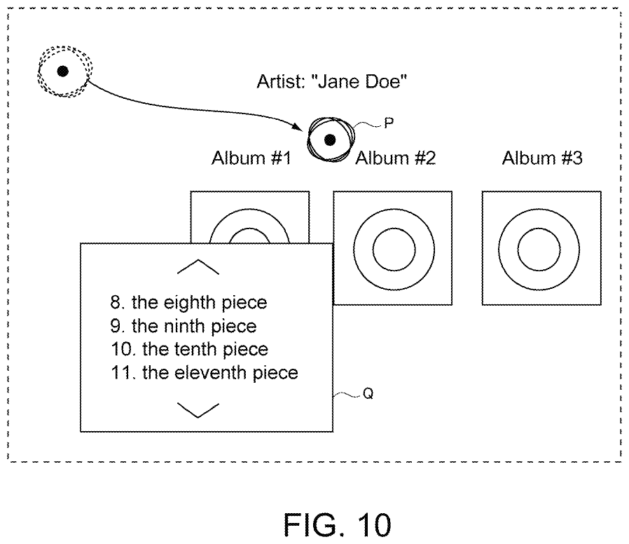

FIG. 10 shows an example in which a music list of an album, which is related information Q of the second album discriminated as the object of interest of the user, is displayed after the dot has moved from the state of FIG. 9.

### ST206 to S208: Two-Step Selection

The controller 10 of the AI speaker 100a moves the dot to the one selected by the user once, instead of immediately executing the processing related to the one selected by the user, as described above. In this embodiment, selecting the operation input selected by the user through two steps in such a manner is referred to as “two-step selection”. Note that such a step may be performed in two or more steps. The step of moving the dot may be referred to as a “semi-selected state”. Also, the “one selected by the user” is referred to as an “object of interest of the user”.

In the semi-selected state, the controller 10 controls the related information Q of the object of interest of the user to be displayed on the display screen 200. The related information Q is displayed so as to be superimposed on a margin portion in the vicinity of the object of interest or on a layer on the object of interest. Further, in the semi-selected state, the controller 10 controls the dot to be displayed in a changed color or form. At the same time, the controller 10 controls the color or form of part or all of the object of interest to be changed and displayed. For example, when the speech agent supports an application of the audio player, the controller 10 produces effects of changing the color of the photograph of the cover of a music album in the semi-selected state to a more noticeable color than that in the non-selected state, tilting the photograph, or floating the photograph.

As the details of the related information Q, part of the details to be displayed on the next screen of the application is given an example. For example, in the case of the audio player described above, a music list of the music to be displayed on the next screen, detailed information of the content, and recommendation information are displayed as the related information Q. In addition, as the related information Q, menu information for reproduction control of music, deletion, and playlist creation may be displayed.

In the semi-selected state, the controller 10 accepts cancellation of the semi-selected state on the basis of the behavior of the user. When the object of interest of the user is in the semi-selected state, the movement of the indicator P allows the user to recognize that the user has erroneously operated or that the user's operation has been erroneously recognized by the AI speaker 100a.

In this semi-selected state, when the detection unit 20 detects behavior of the user indicating negative, for example, a user's speech such as “it is not the one” or a gesture such as shaking the head laterally, the controller 10 cancels the semi-selected state of the object of interest.

The controller 10 sets the object of interest to a fully selected state when the semi-selected state of the object of interest of the user is maintained for a predetermined time or when the behavior of the user indicating positive, such as a gesture of a nod, is detected.

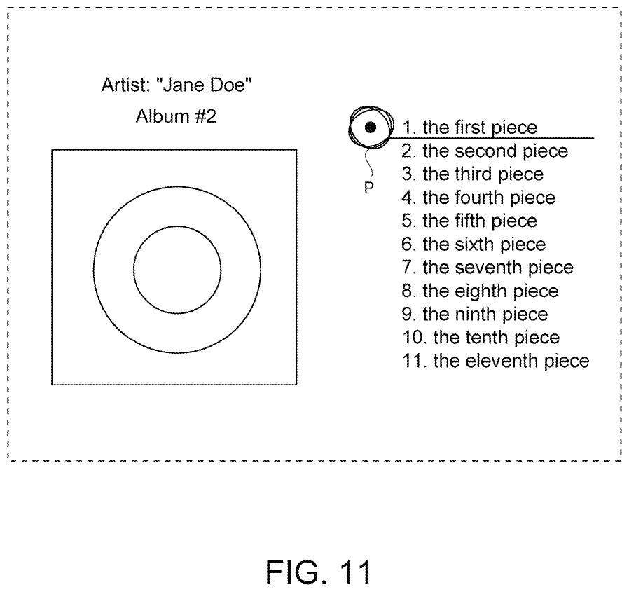

FIG. 11 shows a display example in a state where the user further makes a speech including positive details such as “the user reproduces it”, and the selection of the “second album” in the semi-selected state is determined, from the state of FIG. 10. After the selection is determined, the controller 10 subsequently executes the discrimination processing (ST201 to ST205) for the object of interest of the user. As a result, FIG. 11 shows a state where the display position of the “song list”, which has been the related information Q of the object of interest of the user in FIG. 10, is changed and the dot indicates the song being reproduced in the song list.

### Effect of Second Embodiment

In the above embodiment, in the AI speaker 100a, the dot (indicator P) is displayed on the screen, and the “agent” is represented by the dot, and thus the user can smoothly select and obtain content information according to the above embodiment.

In addition, in the above embodiment, since the discriminated object of interest is further selected after entering a selection preparation state, it is possible to wait for confirmation by the user while the object of interest is in the selection preparation state. Besides, when the discriminated object of interest is in the selection preparation state, the object of interest is set to enter a non-selected state in accordance with the behavior of the user, so that it is possible to accept cancellation by the user while the object of interest is in the selection preparation state.

Further, in the above embodiment, since the state of the AI speaker 100a is displayed by the indicator P, the user can easily confirm the state of the AI speaker 100a. Therefore, according to this embodiment, the operability of the AI speaker 100a is improved. Here, the “state of the AI speaker 100a” includes, for example, whether or not an activation word is necessary, whether or not a voice input of someone is selectively received, and the like.

In the above embodiment, since the content information located ahead of the line of sight of the user is set as a candidate of the object of interest of the user, and then the object of interest is discriminated on the basis of the behavior, the possibility that the content information is the object of interest of the user increases.

### Modified Examples of Second Embodiment

Hereinafter, modified examples of the above embodiment will be described.

### Display Control When Behavior of User can be Interpreted in Multiple Meanings

In the above embodiment, there is a case where, as a result of analyzing the behavior of the user by the controller 10, the behavior can be interpreted in a plurality of meanings, for example, a case where a homonym is spoken by the user. In this case, there is a problem that the interpretation of the user's speech by the speech agent is different from the intention of the user.

In this regard, in this modified example, when two or more candidates can be extracted as the object of interest of the user at the time of analyzing the behavior of the user, the controller 10 shows an operation guide and then shows the two or more candidates in the operation guide.

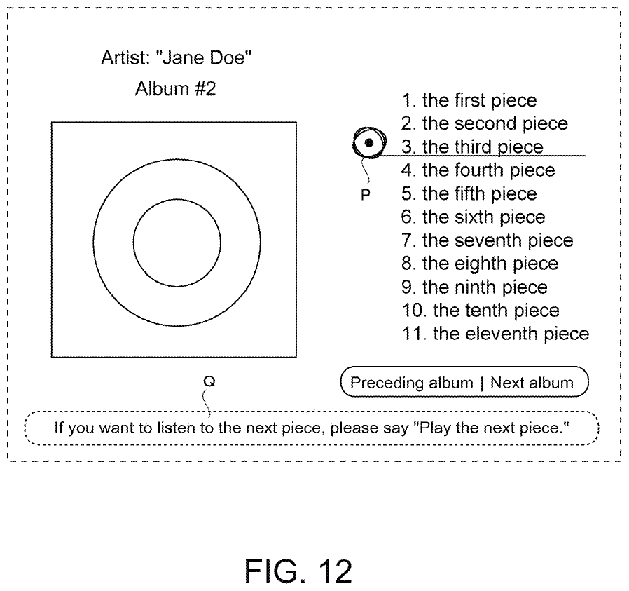

FIGS. 12, 13, and 14 are diagrams showing a screen display example in this modified example. FIGS. 12, 13 and 14 show an audio player.

In FIG. 12, the indicator P is displayed in the vicinity of the third music piece, “the third piece”, of “Album #2”. Since the third music piece “the third piece” of “Album #2” is discriminated as an object of interest of the user, the controller 10 displays an operation guide (an example of the related information Q).

When the behavior of the user is detected in this state, for example, if the user says only “Next”, the controller 10 fails to determine whether the object of interest of the user is the “next song” or the “next album”. In such a case, the controller 10 splits the indicator P in the two-stage selection (ST206 to ST208), and moves the split indicator P and indicator P1 to the respective objects of interest of the user extracted by the controller 10.

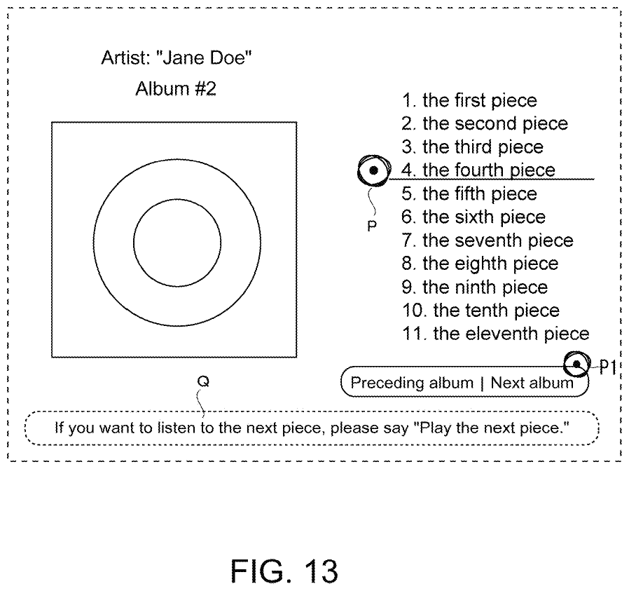

FIG. 13 shows the screen display example in this case. FIG. 13 exemplifies the feedback by the controller 10 when the user says “Next” in a state where the third music piece is being reproduced as shown in FIG. 12. In this case, the controller 10 returns the feedback that causes a user interface (e.g., a button or the like) capable of selecting the “next song” or the “next album” to shine (FIG. 13). Note that, if a music piece whose title (name) includes the word “next” is present on the screen, the controller 10 causes the “next” portion of the title to shine.

The controller 10 splits the indicator P and moves the indicator P and the indicator P1 on or in the vicinity of both the item indicating the fourth musical piece, which is the next musical piece, and a control button for moving to the next album.

Further, according to the intensity of the discrimination in which the object of interest of the user is discriminated, the controller 10 may display an object of interest strongly discriminated in a more conspicuous manner than an object of interest weakly discriminated. Here, the controller 10 may calculate the intensity on the basis of the past operation history, such as whether the user has selected the “next song” or the “next album” after saying “next” in the past.

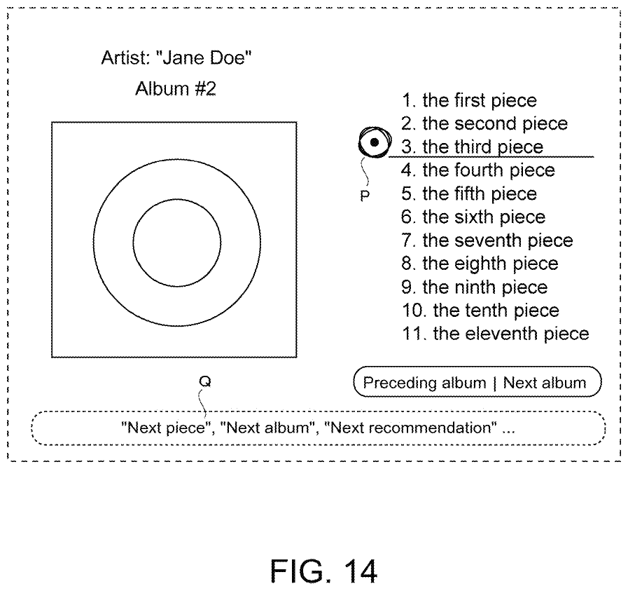

Further, in this modified example, the controller 10 shows the operation guide (an example of the related information Q) in the margin or the like of the display screen 200. As shown in FIG. 14, the controller 10 may show only the operation guide without splitting the indicator. The controller 10 may display items associated with “next” such as “next song”, “next album”, and “next recommendation” as candidates in the operation guide, and prompt the user to perform the next operation by voice.

In the conventional speech agent, the following procedure has been taken: the speech agent asks the user again about the user's speech that can be interpreted in multiple meanings. According to this modified example, feedback is returned in which the operation guide is shown without asking back or the indicator P indicates a portion related to the speech, so that the user does not need to repeat the speech for the operation.

As described above, in this modified example, since the indicator P is moved in the direction of each object of interest when a plurality of objects of interest is discriminated, the possibility of performing an operation against the intention of the user is reduced even when one object of interest based on the behavior of the user is not determined.

### Moving Mode to Enhance Attraction Effect

In the second embodiment, there is no particular limitation on the moving route through which the indicator is moved to the object of interest of the user (ST205), but the controller 10 may move the indicator so as not to pass through the shortest route. For example, the dot may be moved so as to start moving after rotating once in situ just before starting moving. According to this modified example, the attraction effect of the display is enhanced, and the possibility of the user overlooking the display is reduced.

Further, when the dot is moved over a portion where portions with a high contrast ratio between the pixels of the image displayed on the display screen 200 are continuous, the controller 10 may move the dot at lower speed. According to this modified example, the attraction effect of the display is enhanced, and the possibility of the user overlooking the display is reduced.

### Multiple Speech Agents

In the AI speaker 100a according to the above embodiment, in addition to using one speech agent by a plurality of persons, a plurality of speech agents may be used by a plurality of persons. In this case, a plurality of speech agents is installed in the AI speaker 100a. Further, the controller 10 of the AI speaker 100a switches the color or form of the indicator representing the speech agent with which the user interacts, for each speech agent. As a result, the AI speaker 100a can show, to the user, which speech agent is activated.

Note that the indicators representing the plurality of speech agents are configured to have not only different colors and forms (including sizes), but also different elements perceivable by a sense of vision, a sense of hearing, or the like such as the speed of movement, sound at appearing, sound effects at the time of movement, and time from appearing to disappearing. Further, if a hierarchical structure such as “a main agent and a subagent” is provided between the plurality of speech agents, the main agent may be configured to disappear slowly, whereas the subagent may be configured to disappear faster than the main agent. In this case, the main agent may be configured to disappear after the subagent disappears.

Among the plurality of speech agents, a speech agent made by a third party may exist in addition to the genuine manufacturer speech agent of the AI speaker 100a. In this case, the controller 10 of the AI speaker 100a changes the color or form of the indicator representing the speech agent when the speech agent made by the third party is supporting the user.

In home use, the AI speaker 100a may be configured to provide different speech agents for each individual, such as “husband's speech agent” and “wife's speech agent”. In this case as well, the controller 10 changes the color or form of the indicator representing each speech agent.

Note that a plurality of speech agents corresponding to family members may be configured such that, for example, an agent used by a husband responds only to a husband's voice, and an agent used by a wife responds only to a wife's voice. In this case, the controller 10 compares the voice print of each registered individual with voice input from the microphone 16, and identifies each individual. Further, in this case, the controller 10 changes the reaction speed according to the identified individual. The AI speaker 100a may also be configured to have a family agent for use by all family members, and the family agent may be configured to respond to the voices of all family members. According to such a configuration, it is possible to provide a personalized speech agent, and optimize the operability of the AI speaker 100a for each user. Note that the reaction speed of the speech agent may be changed not only according to the identified user but also according to the distance between the speaker and the AI speaker 100a or the like.

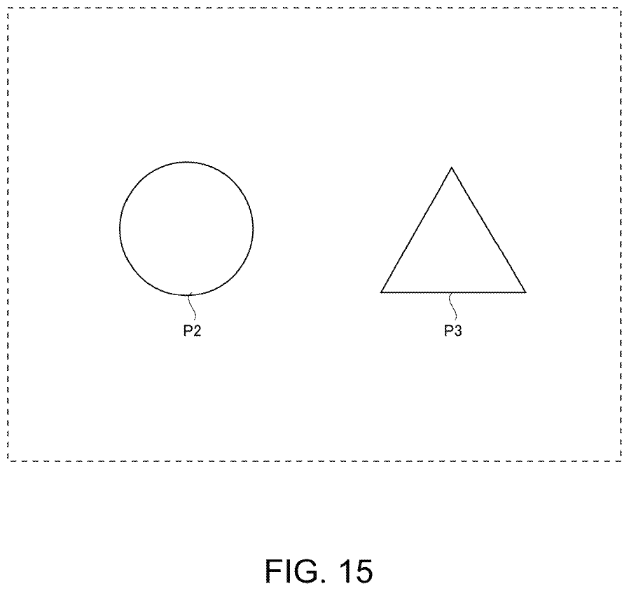

FIG. 15 is a screen display example in which an indicator P2 and an indicator P3 representing multiple speech agents are displayed on the display screen 200 in this modified example. The indicator P2 and the indicator P3 in FIG. 15 represent different speech agents.

In this modified example, the controller 10 discriminates the speech agent on which the user is acting on the basis of the behavior of the user, and the discriminated speech agent discriminates the object of interest of the user on the basis of the behavior of the user. For example, when the behavior of the user is assumed as the line of sight of the user, the controller 10 discriminates the speech agent represented by the indicator P located ahead of the line of sight of the user as the speech agent on which the user is acting.

When failing to discriminate the speech agent on which the user is acting or when failing to execute a user's operation instruction based on the behavior of the user by the discriminated speech agent, the controller 10 automatically determines a speech agent that executes a user's operation instruction based on the behavior of the user.

For example, only a speech agent having a function of output to a display device such as the projector 17 can execute an operation instruction based on a user's speech, “Show mails” or “Show photographs”. In this case, the controller 10 sets a speech agent having a function of output to the display device as a speech agent for executing an operation instruction of the user based on the behavior of the user.

The controller 10 may preferentially select a genuine manufacturer speech agent of the AI speaker 100a over a speech agent of a third party when automatically determining a speech agent for executing an operation instruction of the user based on the behavior of the user. Conversely, the speech agent of the third party may be preferentially selected. In the automatic selection of the speech agent, the controller 10 may prioritize the speech agents on the basis of elements such as whether the speech agent is free of charge or not, whether it is popular or less popular, and whether the manufacturer wants to recommend its use, in addition to the above example. In this case, for example, the priority is set to be higher if the speech agent is charged, if it is popular, or if the manufacturer wants to recommend its use.

In this modified example, when the user says, “Play music”, while looking at the indicator P2 in FIG. 15, a music distribution service configured to be activated in conjunction with the speech agent represented by the indicator P2 is activated. Similarly, when the user says the same, “Play music”, while looking at the indicator P3, a music distribution service configured to be activated in conjunction with the speech agent represented by the indicator P3 is activated. That is, if the details of the utterance are the same, an operation instruction of different details is input to the AI speaker 100a for each speech agent spoken to. However, even when the user speaks while looking at the indicator P2, if the speech agent corresponding to the indicator P2 does not have a music reproduction function, the speech agent corresponding to the indicator P3 may be configured to reproduce music instead. Further, in this case, the speech agent corresponding to the indicator P2 may be configured to ask the user whether the speech agent corresponding to the indicator P3 may reproduce music.

Further, when the details of the user's utterance are ambiguous and interpreted in various meanings, the controller 10 interprets a command to the AI speaker 100a based on the content of the user's utterance and executes the command on the basis of the main use application of the speech agent spoken to. For example, when the user says, “Tomorrow?”, the controller 10 discriminates a speech agent spoken to by the user on the basis of the behavior of the user, and displays the weather of tomorrow if the speech agent is an agent for telling a weather forecast or displays the schedule of tomorrow if the speech agent is an agent for schedule management. The method of discriminating the speech agent spoken to may be a method of specifying not only the line of sight of the user but also the direction of the user's finger on the basis of the image information input from the image sensor 15, and extracting the indicator representing the speech agent located in such a direction.

As shown in FIG. 15, when the controller 10 displays the indicators P representing a plurality of speech agents on the display screen 200, the user can easily discriminate the speech agent on which the user is acting, because the user clarifies the target of the behavior of the user such as pointing with a finger or the line of sight.

In this modified example, the controller 10 produces effects of causing each speech agent to return feedback on the behavior of the user by means of the indicator P representing the speech agent. For example, when the user calls a speech agent related to the indicator P2, the controller 10 performs display control such that only the indicator P2 moves slightly in the direction of the voice in response to the user's call. In addition to the movement of the indicator P, the effects in which the indicator P is distorted in the direction of the user who has spoken may be produced.

For example, in a case where a family uses speech agents corresponding to individuals of the family, when the mother calls a speech agent for use by the father, the controller 10 returns a reaction visually perceivable, such as distortion or shaking of the speech agent, to the mother's call. However, display is controlled such that a command itself based on the speech is not executed, or movement other than the above-mentioned reaction, such as movement toward the voice of the mother, is not performed. As described above, in the case where the AI speaker 100a includes a plurality of speech agents corresponding to the members of the user group, when a certain user speaks to a speech agent corresponding to another user, the controller 10 performs effects such that the speech agent spoken to returns a reaction perceivable by a sense of vision or the like, such as distortion or shaking, but does not execute a command itself based on the speech. According to this configuration, it is possible to return appropriate feedback to the user who has spoken. In addition, it is possible to notify the user of a situation where the voice of a user's utterance is input to the speech agent, but a command based on the utterance cannot be executed.

Further, the AI speaker 100a may be configured to be able to set the intimacy for each of a plurality of speech agents. Further, in this case, in response to the user's action on each speech agent, the speech agent receiving the action may move, and the intimacy may increase. This may allow the user to feel as if the speech agent existed in reality. Note that the action referred to here is behavior of the user, such as speaking or giving a hand. The behavior of the user is input to the AI speaker 100a by the detection unit 20 such as the image sensor 15. Further, in this case, the way of pointing information may be configured to change according to the intimacy. For example, in a case where the intimacy between a certain user and a certain speech agent exceeds a predetermined threshold value at which they are considered to get friendly, the following effects may be produced in which, when pointing the information, the information is once directed in a direction opposite to the direction in which the information is displayed. According to such a configuration, it is possible to cause the indicator to move with a sense of fun.

Further, when the indicators P representing a plurality of speech agents are displayed on the display screen 200, the controller 10 of the AI speaker 100a specifies the speech agent to which the user is speaking on the basis of the behavior of the user, for example, the behavior of pointing to or looking at the indicator P on the display screen 200.

### Supplementary Note Regarding Above Modified Examples

The technical matters disclosed in the above-described embodiments or modified examples may be combined with each other.

### Supplementary Note

Note that the present technology may take the following configurations.

(1) An information processing apparatus, including

a controller that
outputs content information and an indicator representing an agent onto a display screen,
discriminates an object of interest of the content information on the basis of behavior of a user, and
moves the indicator in a direction of the object of interest.
   (2) The information processing apparatus according to claim 1, in which

the controller displays related information of the object of interest in response to movement of the indicator in the direction of the object of interest.

(3) The information processing apparatus according to claim 1 or 2, in which

the controller
changes, after discriminating the object of interest, a display state of the indicator to a display state indicating a selection preparation state, and
selects the object of interest when recognizing behavior of the user that indicates a selection of the object of interest during the display state indicating the selection preparation state of the indicator.
   (4) The information processing apparatus according to claim 3, in which

the controller sets the discriminated object of interest to a non-selected state when recognizing that the behavior of the user is negative about the selection of the object of interest during the display state indicating the selection preparation state of the indicator.

(5) The information processing apparatus according to any one of claims 1 to 4, in which

the controller
splits, when discriminating a plurality of the objects of interest on the basis of the behavior of the user, the indicator into indicators in number of the discriminated objects of interest, and
moves the split indicators in respective directions of the objects of interest.
   (6) The information processing apparatus according to any one of claims 1 to 5, in which

the controller controls at least one of moving speed, acceleration, a trajectory, a color, or luminance of the indicator in accordance with the object of interest.

(7) The information processing apparatus according to any one of claims 1 to 6, in which

the controller
detects a line of sight of the user on the basis of image information of the user,
selects content information located ahead of the detected line of sight as a candidate of the object of interest, and
discriminates, when subsequently detecting the behavior of the user for the candidate, the candidate as the object of interest.
   (8) The information processing apparatus according to any one of claims 1 to 7, in which

the controller
discriminates the object of interest on the basis of the behavior of the user and also calculates accuracy information indicating a degree of certainty indicating that the user is interested in the object of interest, and
moves the indicator in accordance with the accuracy information such that a movement time of the indicator becomes shorter as the certainty becomes higher.
   (9) The information processing apparatus according to any one of claims 1 to 9, in which

the controller
detects a line of sight of the user on the basis of image information of the user, and
moves the indicator ahead of the detected line of sight at least once and then moves the indicator in the direction of the object of interest.
   (10) An information processing method, including:

outputting content information and an indicator representing an agent onto a display screen;

discriminating an object of interest of the content information on the basis of behavior of a user; and

moving the indicator in a direction of the object of interest.

(11) A program that causes a computer to executes the steps of:

outputting content information and an indicator representing an agent onto a display screen;

discriminating an object of interest of the content information on the basis of behavior of a user; and

moving the indicator in a direction of the object of interest.

### REFERENCE SIGNS LIST

10 controller

### 11 CPU

### 12 ROM

### 13 RAM

14 bus
15 image sensor
16 microphone
17 projector
18 speaker
19 communication unit
20 detection unit
21 output unit
100 information processing apparatus
100a, 100b AI speaker
200 display screen
P indicator
Q related information

1. An information processing apparatus, comprising
a controller that
outputs content information and an indicator representing an agent onto a display screen,
discriminates an object of interest of the content information on a basis of behavior of a user, and
moves the indicator in a direction of the object of interest.

2. The information processing apparatus according to claim 1, wherein
the controller displays related information of the object of interest in response to movement of the indicator in the direction of the object of interest.

3. The information processing apparatus according to claim 1, wherein
the controller
changes, after discriminating the object of interest, a display state of the indicator to a display state indicating a selection preparation state, and
selects the object of interest when recognizing behavior of the user that indicates a selection of the object of interest during the display state indicating the selection preparation state of the indicator.

4. The information processing apparatus according to claim 3, wherein
the controller sets the discriminated object of interest to a non-selected state when recognizing that the behavior of the user is negative about the selection of the object of interest during the display state indicating the selection preparation state of the indicator.

5. The information processing apparatus according to claim 1, wherein
the controller
splits, when discriminating a plurality of the objects of interest on a basis of the behavior of the user, the indicator into indicators in number of the discriminated objects of interest, and
moves the split indicators in respective directions of the objects of interest.

6. The information processing apparatus according to claim 1, wherein
the controller controls at least one of moving speed, acceleration, a trajectory, a color, or luminance of the indicator in accordance with the object of interest.

7. The information processing apparatus according to claim 1, wherein
the controller
detects a line of sight of the user on a basis of image information of the user,
selects content information located ahead of the detected line of sight as a candidate of the object of interest, and
discriminates, when subsequently detecting the behavior of the user for the candidate, the candidate as the object of interest.

8. The information processing apparatus according to claim 1, wherein
the controller
discriminates the object of interest on a basis of the behavior of the user and also calculates accuracy information indicating a degree of certainty indicating that the user is interested in the object of interest, and
moves the indicator in accordance with the accuracy information such that a movement time of the indicator becomes shorter as the certainty becomes higher.

9. The information processing apparatus according to claim 1, wherein
the controller
detects a line of sight of the user on a basis of image information of the user, and
moves the indicator ahead of the detected line of sight at least once and then moves the indicator in the direction of the object of interest.

10. An information processing method, comprising:
outputting content information and an indicator representing an agent onto a display screen;
discriminating an object of interest of the content information on a basis of behavior of a user; and
moving the indicator in a direction of the object of interest.

11. A program that causes a computer to executes the steps of:
outputting content information and an indicator representing an agent onto a display screen;
discriminating an object of interest of the content information on a basis of behavior of a user; and
moving the indicator in a direction of the object of interest.
